(19) United States
(12) Patent Application Publication
(10) Pub. No.: US 2005/0180101 A1
(43) Pub. Date: Aug. 18, 2005

(54) Portable storage device with interchangeable connector

(76) Inventors: Gordon Yu, Hsin Chu City (TW); Forli Wen, Hsin Chu City (TW); Justin Cheng, Hsin Chu City (TW)

Correspondence Address: SUPREME PATENT SERVICES, POST OFFICE BOX 2339, SARATOGA, CA, 95070, US

(21) Appl. No.: 10/778,767

(22) Filed: Feb. 14, 2004

(51) Int. Cl. G06F 1/16

(52) U.S. Cl. 361/684

(57) ABSTRACT

A portable storage device having interchangeable connector is disclosed. The portable storage device includes a body inside which a memory is arranged and forming an access opening for selectively and exchangeably connecting a number of external connection members and establishing electrical engagement with the memory inside the body. A control circuit inside the body controls data input/output of the portable storage device. Each of the external connection members has a remote end forming a connector element in accordance with a specific data transfer standard, such as USB, IEEE1394, Serial ATA or RS232, whereby the portable storage device can be selectively connected to electronic devices having connection ports of different specifications with specifically selected connector element. Portability of the storage device between different electronic devices is thus enhanced.

### BACKGROUND OF THE INVENTION

1. Field of the Invention

The present invention relates generally to a portable storage device, and in particular to a portable storage device having interchangeable connector whereby the portable storage device is selectively connectable to external devices having interface connections of different specifications or standards.

2. The Related Art

The electronic portable storage devices have gone through a significant change in the history of technological development. Being magnetism based, the magnetic storage devices, such as floppy discs and hard disc drives that are inferior in data access and storage capacity, have been gradually replaced by electronic flash memory based device, such as a compact flash card, which comprises a compact case housing an amount of flash memory units. Such electronic storage devices have faster data access speed and environmental resistance, which means they can maintain normal operation in severe surroundings, such as high humidity, high temperature and high pressure. Thus, electronic storage devices are more advantageous in data transfer between electronic devices and/or computers.

The electronic storage devices currently available make use of Universal Serial Bus (USB) interface to hook up with an electronic device or computer, which is the standard commonly adopted by the electronic and computer industries. However, there are multiple USB standards involved in the electronic and computer industries, including at least A-type USB, B-type USB and mini-USB. In addition, other standards are also available for computer systems, such as IEEE1394. These standards are not mechanically or electronically compatible with each other in general, which often causes troubles to general consumers in transferring data between different electronic devices or computers adopting different data transfer standards. Portability of the data storage devices between different electronic devices is thus difficult. For example, the mini-USB is commonly adopted in digital camera systems, while standard A-type USB is used in general computer systems; thus, an adapter or the likes are required in downloading digital pictures from digital camera to a computer. This causes extra expense and labors in data transfer.

Thus, the present invention is aimed to provide a portable storage device having an interchangeable connector to overcome and eliminate the problems encountered in the prior art.

### SUMMARY OF THE INVENTION

Therefore, a primary objective of the present invention is to provide a portable storage device having an interchangeable connector comprising a plurality of connectors allowing for interfacing of different standard devices with different electronic devices to proceed with uploading, downloading and transfer of data among the devices.

Another objective of the present invention is to provide a portable storage device having interchangeable connector that enhances portability of data storage between electronic devices having exchangeable interfaces among respective standards.

A further objective of the present invention is to provide a portable storage device having interchangeable connector to select electronic devices having exchangeable interfaces among respective standards whereby one data storage device can be used with a number of different electronic devices to reduce the expense required for external data storage.

To achieve the above objectives, in accordance with the present invention, a portable storage device having interchangeable connector is provided, wherein the portable storage device comprises a body inside which at least one memory chip is arranged and forming an access opening for selectively and exchangeably connecting a number of external connection members and establishing electrical engagement with the memory inside the body. A control circuit inside the body controls data input/output of the portable storage device. Each of the external connection members has a remote end forming a connector element in accordance with a specific data transfer standard, such as USB, IEEE1394, Serial ATA or RS232, whereby the portable storage device can be selectively connected to electronic devices having connection ports of different specifications with the specifically selected connector element. Portability of the storage device between different electronic devices is thus enhanced.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a portable storage device constructed in accordance with the present invention with an connection member detached therefrom; and

FIG. 2 is a block diagram schematically showing the connection of the portable storage device of the present invention with an external electronic device.

### DETAILED DESCRIPTION OF THE PREFERRED EMBODIMENT

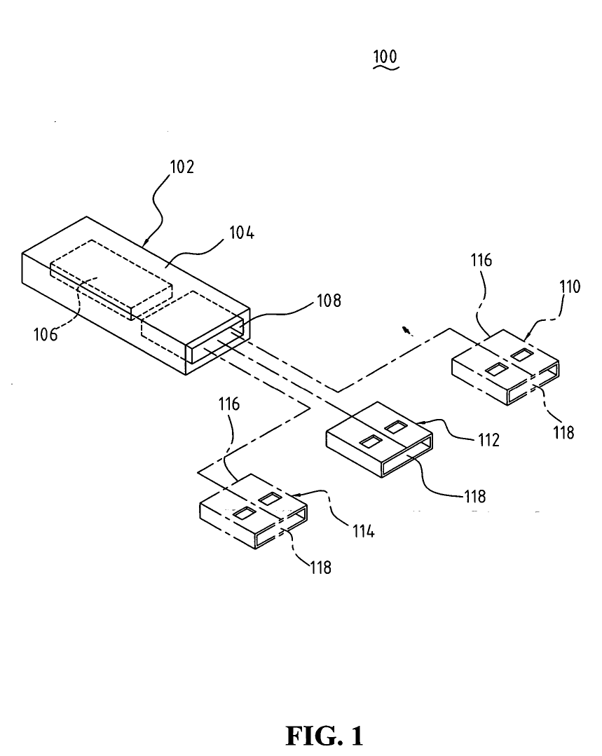

With reference to the drawings and in particular to FIG. 1, a portable storage device constructed in accordance with the present invention, generally designated with reference numeral 100, comprises a rectangular bar like body 102 that comprises electronic memory elements 106, such as flash memory or random access memory (RAM), housed in a casing 104. If desired, memory other than electronic ones can be alternatively or additionally employed in the portable storage device 100 of the present invention. The memory elements 106 are mounted on a circuit board that is fixed in an interior space inside the casing 104. The circuit board of the memory elements 106 is provided with input/output means (not shown) that allows for transfer-in and transfer-out of electronic signals for data storage/retrieval purposes. Such input/output means is generally known in the art and no further detail will be given herein.

The casing 104 forms an access opening 108 at an end thereof. The access opening 108 is in communication with the interior space of the casing 104 and corresponds to the input/output means of the circuit board of the memory 106.

The portable storage device 100 further comprises a number of external connection members, which in the embodiment illustrated are three, respectively designated with reference numerals 110, 112, 114. However, it is noted that the number of the external connection members can be increased or decreased as desired. Each external connection member 110, 112, 114 has a first, proximal end 116 having a physical size and shape tightly and removably receivable in the access opening 108 of the casing 104 and forming electrical engagement with the input/output means of the circuit board of the electronic memory 106. Thus, the external connection members 110, 112, 114 can be exchangeably and selectively fit into the access opening 108 to electrically connect the electronic memory 106 inside the casing 104.

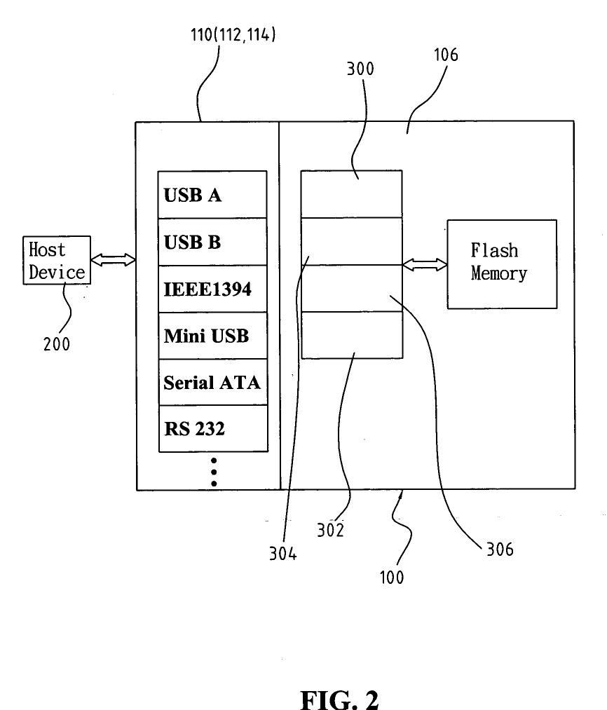

Each external connection member 110, 112, 114 has a second, remote end 118 which is made respectively in accordance with different data transfer standards, such as A-type USB, B-type USB, mini-USB, IEEE1394 and serial ATA and RS232. Thus, proper electrical and data connection with an external electronic device (such as a host device 200, see FIG. 2) of a specific standard can be established between the electronic device 200 and the portable storage device 100 by properly selecting a desired one of the external connection members 110, 112, 114. Data can thus be downloaded from, uploaded to and transfer between the portable storage device 100 and the host device 200.

Also referring to FIG. 2, the portable storage device 100 comprises a control circuit 300 comprised of a central processing unit 302 that controls the operation of data transfer through the portable storage device 100, memory 306 for temporary storage of the transferred data and a power source 304 driving the central processing unit 302 and the memory 306, as well as the electronic memory 106. The control circuit 300 functions to at least convert data of different specifications for enhancing storage and retrieval of data in and out of the electronic memory 106. Such a control circuit 300 is generally known to those having ordinary skills in the art and thus no further detail is needed.

By means of the interchangeable connector comprised of a number of external connection members 110, 112, 114 that are selectively and removably connected with the memory elements 106 inside the storage device 100, the portable storage device 100 is allowed to selectively connect electronic devices that adopt different data transfer standards. Thus, data transfer and thus portability of the data storage among different electronic devices is enhanced. Limitation caused by different data transfer standards is also eliminated by the present invention. In addition, cost for data transfer and storage is substantially reduced.

Although the present invention has been described with reference to the preferred embodiment thereof, it is apparent to those skilled in the art that a variety of modifications and changes may be made without departing from the scope of the present invention which is intended to be defined by the appended claims.

1. A portable storage device comprising:
a body defining an interior space and an access opening in communication with the interior space;
a memory arranged inside the body and having input/output means corresponding in position to the access opening; and
a first external connection member having a first end removably receivable in the access opening and engageable with the input/output means of the memory and a second end forming a connector element in accordance with a first data transfer standard adapted to mate a counterpart element provided in an external device thereby connecting the memory to the external device.

2. The portable storage device as claimed in claim 1, wherein the connector element of the second end of the first external connection member comprises an A-type Universal Serial Bus (USB) connector.

3. The portable storage device as claimed in claim 1, wherein the connector element of the second end of the first external connection member comprises a B-type Universal Serial Bus (USB) connector.

4. The portable storage device as claimed in claim 1, wherein the connector element of the second end of the first external connection member comprises an IEEE1394 connector.

5. The portable storage device as claimed in claim 1, wherein the connector element of the second end of the first external connection member comprises a mini Universal Serial Bus (USB) connector.

6. The portable storage device as claimed in claim 1 further comprising a second external connection member having a first end identical to the first end of the first external connection member adapted to removably fit into the access opening of the body and engage the input/output means of the memory for replacing the first external connection member, the second external connection device having a second end forming a connector element in accordance with a second data transfer standard adapted to mate a counterpart element provided in an external device thereby connecting the memory to the external device, the second data transfer standard being different from the first data transfer standard.

7. The portable storage device as claimed in claim 1, wherein the memory comprises flash memory.

8. The portable storage device as claimed in claim 1 further comprising a control circuit arranged inside the body for control of writing of data into the memory and retrieval of data from the memory.

9. The portable storage device as claimed in claim 8, wherein the control circuit comprises. central processing unit.

10. The portable storage device as claimed in claim 9, wherein the control circuit comprises memory.

11. The portable storage device as claimed in claim 1 further comprising a power source inside the body.

12. A portable storage device comprising:
a body defining an interior space and an access opening in communication with the interior space;
a memory arranged inside the body and having input/output means corresponding in position to the access opening;
a first external connection member having a first end removably receivable in the access opening and engageable with the input/output means of the memory and a second end forming a connector element in accordance with a first data transfer standard adapted to mate a counterpart element provided in a first external device thereby connecting the memory to the first external device; and
a second external connection member having first end having a structure identical to the first end of the first external connection member and alternatively and removably receivable in the access opening and engageable with the input/output means of the memory so as to replace the first external connection member and a second end forming a connector element in accordance with a second data transfer standard, which is different from the first data transfer standard, adapted to mate a counterpart element provided in a second external device thereby connecting the memory to the second external device.

13. The portable storage device as claimed in claim 12, wherein the memory comprises flash memory.

14. The portable storage device as claimed in claim 12 further comprising a control circuit arranged inside the body for control of writing of data into the memory and retrieval of data from the memory.

15. The portable storage device as claimed in claim 14, wherein the control circuit comprises central processing unit.

16. The portable storage device as claimed in claim 15, wherein the control circuit comprises memory.

17. The portable storage device as claimed in claim 12 further comprising a power source inside the body.
